(19) United States
(12) Patent Application Publication
(10) Pub. No.: US 2004/0024760 A1
(43) Pub. Date: Feb. 5, 2004

(54) System, method and computer program product for matching textual strings using language-biased normalisation, phonetic representation and correlation functions

(75) Inventors: James Toner, Greystones (IE); Amin Fayez Jamal, East Orange, NJ (US)

Correspondence Address: DERGOSITS & NOAH LLP, Four Embarcadero Center, Suite 1450, San Francisco, CA, 94111, US

(73) Assignee: Phonetic Research Ltd., Greystones (IE)

(21) Appl. No.: 10/209,741

(22) Filed: Jul. 31, 2002

(51) Int. Cl. G06F 17/30; G06F 7/00

(52) U.S. Cl. 707/6

(57) ABSTRACT

A method, system and computer program product for transformation, normalization and correlation techniques that are effective for matching names of foreign origin that may be spelt in any number of ways. It addresses the problem of matching names that may belong to the same person but may be spelt differently. The main technique is to convert both strings to be matched into a representation of their original language, i.e., transform them into idealized (normalized) versions of themselves based on their true spelling in their original, native language. This process of idealization can be done either by employing a dictionary of standard, idealized names, or by implementing the idealization in real time by following a finite-state algorithm to convert the strings into their true representation in their original language. The idealization process can be viewed as a phonetic searching method, as it resolves the problem of vowel representations or their incorrect use as well as handling the representation of consonants that do not exist in the English language. Further probabilistic and elastic matching techniques, using a correlation function, can be invoked manually or automatically to match names where the quality of or the completeness of names may be suspect. A new approach to “probabilistic” and “sliding-elastic” matching (which give a level of confidence as a percentage against each match) can be used with or without the phonetic (idealized) searching function. The results of the search are displayed on the computer screen or printed, showing all the successful matches, together with the type of search that has been used to obtain the match. Results can be filtered by comparing attributes of the persons associated with the Suspect and Data names (such as age, country of birth, etc.) to minimize reporting on irrelevant matches.

### CROSS-REFERENCE TO RELATED APPLICATIONS

Not applicable.

### STATEMENT REGARDING FEDERALLY-SPONSORED RESEARCH AND DEVELOPMENT

Not applicable.

### BACKGROUND OF THE INVENTION

1. Field of the Invention

The present invention relates to search technologies and/or data association. In an embodiment, the invention relates to matching names (such as Muslim/Arabic/Eastern/Asian names and other foreign names) against names held in computer databases or files, by accommodating the large variety of possible spellings, representations, corruption, and deliberate or inadvertent concatenation and misspellings.

2. Related Art

Most Asian names, such as Middle Eastern names, when transcribed into English, can be written with various spellings. For example, the Muslim name “Mohamed” can be represented as “Mohammed,” “Muhhamad,” “Muhamud,” “Imhamed,” etc. The same Muslim name can be spelt differently when it is transcribed into the Latin alphabet. Thus, one man can have his name held in different databases with different spellings, i.e., databases containing foreign names transcribed into Western languages are likely to hold the different spellings of the same name, making it ineffective to employ traditional exact-matching methods to establish whether or not a specific name exists within a database. When searching for a specific Muslim name, the large variations of possible spellings would render existing matching methods ineffective for the following reasons:

1. Non-Standard Ways of Splitting and Concatenation

Asian and Middle Eastern names may be concatenated or split in different ways, for example, the following names are identical when written in Arabic, but not when transcribed into English:

1. “Abdul rahim al Majdy”

2. “Abed Alraheem al Majdy”

3. “Abdurraheem al-Magdy’

Exact-matching search techniques would certainly fail when faced with this kind of problem.

2. Representation of Vowels and Diacritical Marks

Vowels in Arabic/Urdu/Farsi languages can either be:

a) implied, (by diacritical marks which are not normally written) and which are not strongly pronounced, or

b) definite, (by letters representing strong vowels) and which are written within the text and are strongly pronounced.

Both types can lead to different Latin spellings when a name is transcribed into English, as different individuals may choose a different English vowel to produce a pronunciation corresponding to the original, native pronunciation. For example, the name “Majeed” can be represented as “Majid” and “Mahmood” as “Mahmud.”

3. Double Letter Representation

Double letters in Middle Eastern names are normally indicated by a specific diacritical mark and not by the duplication of the letter. When transcribed into English, a double letter in a name may be represented by a single or by a double letter. For example, the name “Mohamed” can be often found as “Mohammed.”

4. Non-Standard Use of Hyphenation

Hyphenation is not common in Eastern/Asian languages, yet it is frequently employed when transcribing Eastern names into Latin representation. However, there are no standard rules on the way hyphenation may be used. For example, the name “Alhaj” may be frequently written as “Al-Haj.”

5. Letters and Consonants that do not Exist in English

Middle Eastern alphabets, such as Arabic/Farsi and Urdu, contain many letters that do not exist in the Latin alphabet. There are many possible spelling variations when transcribing such letters into the Latin alphabet. For example, the name “Ghalib” is sometimes represented as “Galib” or “Kalib” or “Qalib.”

6. Representation of Glottal Stops

In Arabic and many Eastern languages, the glottal stop is a basic letter in its own right and can also be combined with other letters to change pronunciations. Names containing glottal stops are particularly difficult to transcribe into the Latin alphabet, and many people resort to the use of apostrophes or other letters to represent them. However, there is no standard way of representing glottal stops, adding to the difficulty for existing matching methods to cope with this problem.

7. Titles, Aliases, Pseudonyms and Nicknames

Many Eastern names contain honorary titles, aliases and nicknames, and they become part and parcel of the name. Current name matching methods do not discard or isolate these supplementary words.

The above problems point to the weakness of existing string comparison tools and name-matching methods to provide effective, comprehensive name matching solutions. Clearly, as there is no standard way of representing foreign names in English, exact-matching techniques would fail when it comes to searching for names based on different languages, such as Asian, Middle Eastern and Muslim names. More sophisticated techniques are required to accommodate the large possible variations in spellings.

This invention addresses the problems presented above and describes the techniques for resolving such variations in spellings and representations.

### SUMMARY OF INVENTION

An embodiment of the present invention provides a method, system and computer program product for matching names of foreign origin that may be spelt in any number of ways. It addresses the problem of matching names that may belong to the same person but which may be spelt differently. For the sake of clarity, we define the database names as the Data and the name to be searched for as being the Suspect. The main technique is to transform both Data and Suspect strings into a representation of their original language, i.e., to convert them into ideal versions of themselves based on their true spelling in their original language. This process of idealization or normalization can be done either by employing a dictionary of standard, idealized names (a process that may have performance problems), or by implementing the idealization in real time by following an algorithm to convert the strings into a normalized representation biased to their original, native language.

The idealization process can be viewed as a phonetic transformation method, as it resolves the problem of vowel representations or their incorrect use as well as handling the representation of consonants that do not exist in the English language. The idealization process is realized by a rule-based, finite state algorithm that works on the text by processing a slice (a small number of characters) at a time. In effect, the process moves a window of size n characters across the given string and determines the necessary rule by the sequential position of the finite state machine or by using a look up table.

The probabilistic and elastic matching techniques can be invoked to give a statistical correlation measure to indicate the likelihood that two strings are similar (even though one of them may be corrupted, wrongly concatenated or considerably misspelled). The new approach to ‘probabilistic’ and ‘sliding-elastic’ matching (which gives a level of confidence as a percentage against each match) can be combined with the phonetic (idealized) searching function to increase the chances of obtaining a match. The results of the search are displayed on the computer screen or printed, showing all the successful matches, together with the type of search method employed to obtain the match.

Embodiments of the invention include one or more of the following features:

1. A method, system, and/or computer program product for matching Muslim/Middle Eastern/Asian or Eastern European names that are spelt differently by identifying the nearest idealized representation in their original language.

2. A method, system, and/or computer program product for matching names using an idealization algorithm that converts them into a normalized form of their spelling.

3. A method, system, and/or computer program product for matching names by resolving unusual uses of vowels and double letters in the English representation of Arabic/Muslim/Eastern names.

4. A method, system, and/or computer program product for matching names by focusing on matching consonants and giving vowels a lower importance.

5. A method, system, and/or computer program product of matching names that resolves the problems of representing sounds and consonants that do not exist in the English language.

6. A method, system, and/or computer program product of comparing names using a correlation function that uses a dynamic, elastic matching algorithm that identifies the ratio of sequential letters shared by the two names being compared.

7. A method, system, and/or computer program product of matching names by comparing phonetic representations.

8. A method, system, and/or computer program product for matching names that are tolerant of the positions and use of hyphens and apostrophes.

9. A method, system, and/or computer program product of matching names that use synonyms or equivalent words (such as “Bob” being equivalent to “Robert” or “Fred” being equivalent to “Frederick”).

10. A method, system, and/or computer program product for solving the problem of finding and comparing all the combinations resulting from having multiple synonyms or aliases in the same Suspect name string.

11. A method, system, and/or computer program product for providing a correlation function giving a probabilistic measure of how close two strings are, which can be used to supplement other search techniques. This method is a powerful tool for matching considerably corrupted or grossly misspelled names.

12. A method, system, and/or computer program product for matching names written in different languages (e.g., matching one name written in Arabic ASCII with other names written in English).

13. A method, system, and/or computer program product that can be integrated or embedded within another application to do name-matching.

14. A method, system and/or computer program product that can be embedded on a PC or hand-held device (such as a Palm Pilot or CE based hand held organizer) to facilitate checking of names entered manually on the device (or scanned by the device) against a list of stored names of known suspects/terrorists/criminals.

15. A method, system, and/or computer program product for matching differently spelt names, which can be embedded or invoked within a database application as a stored procedure to automate the matching of names held in relational and object-oriented databases.

16. A method, system, and/or computer program product for embedding the functions within a package that can be invoked by free text search engines to provide fast searching across web/intranet contents.

17. A method, system, and/or computer program product for matching names which tolerates the absence or presence of double letters.

18. A method, system, and/or computer program product for comparing names phonetically that accommodates letters that do not exist in the English alphabet.

19. A method, system, and/or computer program product for improving the performance of the software by pre-processing both database files (such as converting names into their idealized and phonetic versions) and the list of names to be searched for.

20. A method, system, and/or computer program product for verifying any name matched with additional parameters such as date of birth, country of origin, residence details, eye color, etc, to minimize displaying or reporting on irrelevant name-matching results.

The above methods, systems, and/or computer program products can be used for matching names from any language. Additionally, the invention is useful for other applications that involve searching large files of unstructured textual data, or for tolerating the entry of misspelled names into computer applications.

Further features and advantages of the present invention, as well as the structure and operation of various embodiments of the invention, are described in detail below with reference to the accompanying drawings.

### BRIEF DESCRIPTION OF THE DRAWINGS

FIGS. 1, 2, and 4-8 are operational flowcharts of embodiments of the invention.

FIG. 3 illustrates an example synonym table according to an embodiment of the invention.

FIG. 9 illustrates an example computer system according to an embodiment of the invention.

### DETAILED DESCRIPTION OF EMBODIMENTS OF THE INVENTION

Overview

Embodiments of the invention are directed to searching computer databases and electronic files for foreign names (such as Muslim or Middle Eastern names), by accepting and accommodating possible variations in spellings and presentations. The method matches names even when one of them is incomplete, split or concatenated differently, spelt differently, is of a different case, is hyphenated in a different place, or if the words appear in a different order. The matching algorithm accommodates wide variations of spelling, the use of aliases or synonyms, and is tolerant of the existence of additional words or honorary titles within names. The system can either be used for searching one or more databases (or a number of computer files) for a single given name (entered using a keyboard), or in an automated fashion, whereby the program can be used to search database(s) (or computer file(s)) by using a specific file containing a list of names (e.g., of suspects) that need to be searched for. Alternatively, the system can be used to pre-index large unstructured textual files (such as large web or intranet sites) to facilitate subsequent fast searching across all the site(s) contents for rapid matching of names.

This invention rests on the idea that if the matching is done using the original native language of the names, high success factors can be achieved. Thus, the approach is to represent both Data and Suspect names (i.e., the two strings to be matched) in a form that mimics the conversion of the two names into their original, native spelling (or representation). The conversion process may be done by finding the nearest name in a list of pre-defined, standard names, or by using an algorithm and techniques to do the conversion in real time into a form that caters for all possible variations of spelling and splitting and concatenations. The results are given a confidence level (from a string correlation function) presented as a percentage. The user may select a percentage threshold below which matched results would be ignored.

The algorithmic matching process uses a number of techniques to obtain a match between a given name and an entry in a database (or a computer file), as follows: first, both the sought name (called the Suspect name) and the database entry (called the Data) are made case insensitive by converting both to lower (or upper) case. If an exact match is not found (by directly comparing the two strings), then both strings are transformed into their phonetic representatives, taking into account rules relating to Middle Eastern/Muslim and Asian languages and typical names, before further comparison is made on the phonetic representation, not by Soundex. The rules employed take into account the original sounds or pronunciations of the letters, eliminating double letters, and looking for special patterns. If an immediate match is not found, a probabilistic search algorithm is used that matches strings according to the length and number of string fragments shared by the two strings. If no match is found, the search processes are used again after looking for and substituting synonyms, aliases or nicknames, and by looking for the words (within the Suspect name) in any order. The main advantages of an embodiment of this invention are to accommodate large variations of spelling but at the same time provide a quick method for searching large databases without having to do integration or costly development work.

The invention is initially designed to work with names based on Latin (English and European alphabets) and Arabic alphabets (used for Arabic, Farsi and Urdu) but can be used for names based on other languages and can be used for other database searching and data mining applications.

Example of Embodiments

The invention can take many possible embodiments, with the functions embedded in devices or deployed on machines with processing capabilities. Three examples, out of many possible, are given below to illustrate the potential wide use of the invention:

a) Stand-Alone Operation

The invention can be incorporated as a name-matching application on a stand-alone, or a networked PC where it would be used to compare names entered on the keyboard (or read from a file) against names held locally or in a server database. Results can be displayed on the screen and/or stored in a file.

b) Embedded Within Other Applications

The invention can be embedded within a computer system as software routines (or stored procedures) that can be called by other application to facilitate matching of textual strings. An example of such embodiment would be the exploitation of this invention to search large, unstructured text files, such as web or Intranet pages, or structured databases, for matching entered names against textual strings on web sites or against structured data in large databases. The invention can be run in real time or in batch mode.

c) Embedded in a Handheld Device

The invention can be incorporated in a handheld, portable device to check names (entered by an integrated keyboard, virtual keyboard (via and LCD display, or entered by an integrated scanner or camera). An example would be use of a pen-scanner (such as the C-Pen made by C Technologies of Sweden or the Pocket Reader from Siemens) as self-contained name matching systems: they can scan documents (such as passports or driving licenses) and pass the scanned text (the result of the built-in OCR process) to this invention (incorporated within the device) for matching it against a stored list of names. If a match is found, the device displays the results and emits a sound to alert the user.

This embodiment of the invention would provide the means for checking names without relying on centralized systems or large computing resources. It could be used at ports of entry (such as airports) or used by security people on the move (such as police or security agency personnel). The device can be used to check entered names against lists of terrorists or criminals or those wanted for questioning. The stored list of names can be updated by linking the device to a PC via a USB, infrared or other communication methods.

Structure of the Invention

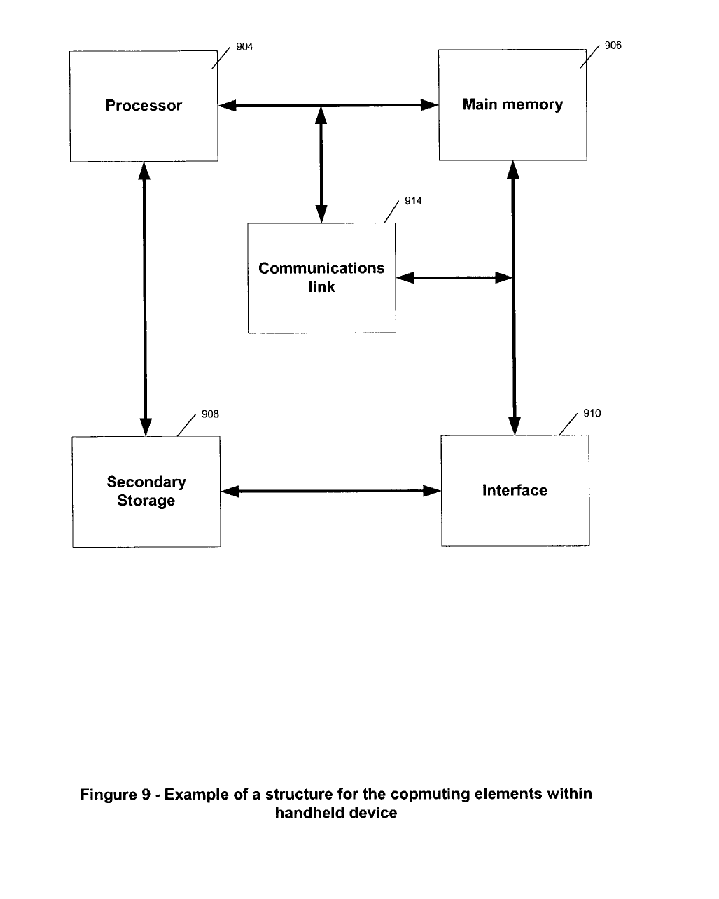

FIG. 9 illustrates an example computer system 902 according to an embodiment of the invention. FIG. 9 is provided for illustrative purposes. Other implementations will be apparent to persons skilled in the art based on the teachings contained herein and fall within the scope and spirit of the invention.

The computer system 902 includes a processor 904, a main memory 906, various secondary storage devices 908, and an interface 910. These modules communicate and interact with each other via, for example, a communication medium 914.

Secondary storage devices 908 include, but are not limited to, hard drives, floppy drives, CD drives, optical drives, etc., as well as computer storage units that operate in such drives, such as floppy disks, CDs, removable hard drives, etc.

The processor 904 operates according to control logic (software). Such control logic is stored in main memory 906 and/or secondary storage 908. Such control logic causes the computer system 902 to operate in the manner described herein.

Control logic is stored in main memory 906 and/or secondary storage 908. Main memory and/or secondary storage 908, having stored therein control logic, is referred to as computer program products.

Control logic may also be received by the computer system 902 via an interface 910. The interface 910 may be a modem, a wireless interface, or a network interface. Signals received by the computer system 902 via interface 910, having control logic embedded or embodied therein, are also referred to herein as computer program products.

The invention is directed to computer program products.

Alternatively, the invention may be implemented in hardware, such as a hardware state machine. In other embodiments, the invention is implemented in combinations of hardware and software systems.

Operation of the Invention

The application compares a Suspect name against names held in database or flat files (Data names). The Suspect name can be a single name entered using the keyboard, or can be read from a file containing any number of Suspect names.

The Data names can be held in a single file or in multiple files, either on the computer running the application or a network server. The application automates the comparison and matching between the Suspect name(s) and the Data names and outputs the result to the screen and to a text file which is automatically saved on the computer running the application.

1. Phonetic matching, where both the Suspect and the Data names are converted into their idealized, phonetic versions before exact and/or any order matching is carried out. The conversion to phonetic representation can either be done by looking up a dictionary of stored idealized words and finding the nearest match, or by using an algorithm to implement the conversion in real time, or by using a look-up table representing linguistic and letter-pair frequency rules. If a phonetic match is found, the results are displayed, with an indication that the match was achieved by exact or any-order phonetic matching.

2. Correlation/probabilistic matching, where slices of the Suspect name are compared one at a time with the Data string. If the ratio of the total number of characters within the slices (that are successfully matched), against the total number of characters in the Suspect name, is higher than a user-selected (threshold) value, a successful match is noted, i.e.,

Ratio=(total number of character in slices matched)×100 number of total characters within Suspect

if Ratio>Threshold % then a successful match is reported (The user can change the threshold at any time)

A slice is initially determined to be of a specific length (initially set to 4 characters). However, its size can dynamically and automatically increase depending on the success or failure of subsequent comparison. This elastic matching is described in more detail later.

1. Name substitution matching, where component words of the Suspect name are checked against a synonym table and are replaced with their respective synonyms. Each component word that is found in the synonym table may have a large number of possible replacements. Thus, if more than one word in the Suspect name is found in the synonym table, the number of string combinations generated to be matched grows considerably. For example, if two words have synonyms, and each word has 5 possible synonyms, a total of 35 other strings are generated:

5 strings containing the synonyms of the 1^{st} word, keeping the second word unchanged, plus

5 strings containing the synonyms of the 2nd word, keeping the first word unchanged, plus

25 string combing the permutations of replacing both words, each with its own 5 synonyms

Main Program

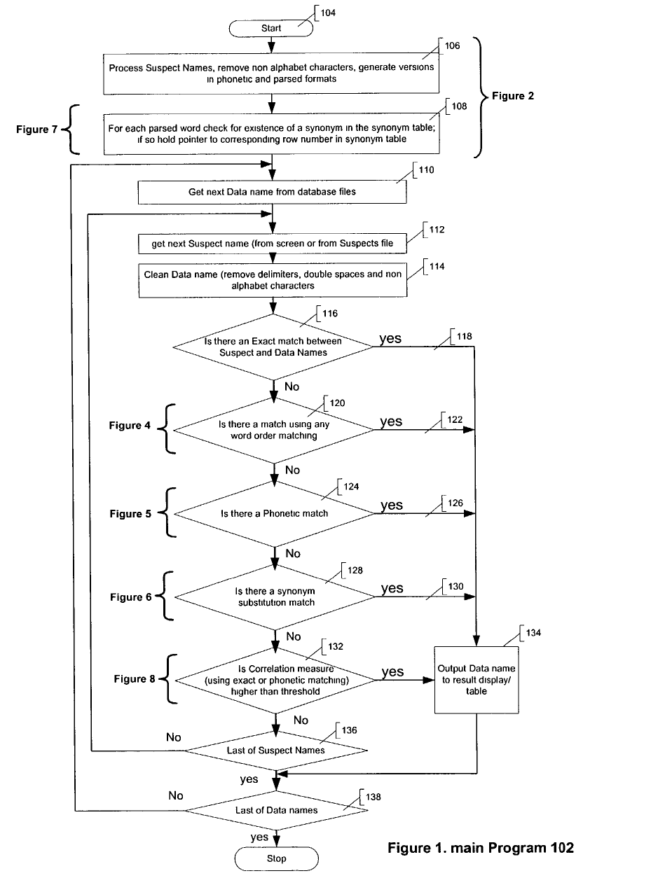

The operation of embodiments of the invention shall be described in greater detail with reference to FIG. 1, which illustrates the operation of a Main Program 102.

In step 106, the invention calls a procedure to get the Suspect name(s) and prepare them for subsequent matching with the Data names. Users select whether they wish to use a single Suspect name at a time, manually entered by the keyboard, or to use an existing file containing a list of Suspect names.

The names are converted into lower case (converting to upper case is also an option) and are stripped of any delimiters and leading space characters; multiple, succeeding space characters are replaced by a single space character. Subsequently, a version of the name is created replacing all space characters with a special delimiter to ease sub-string matching. For each Suspect name, a phonetic version is created as well as a parsed version (separating the component words into single strings).

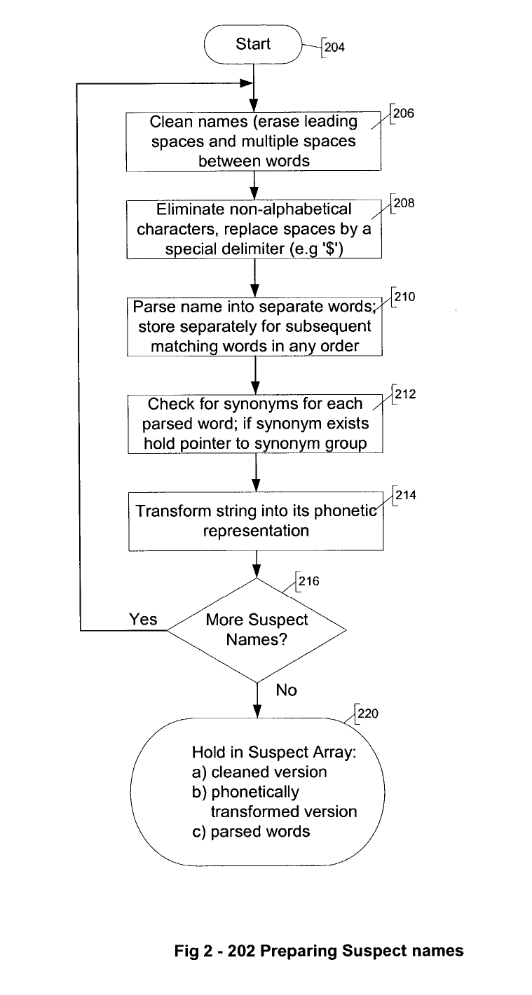

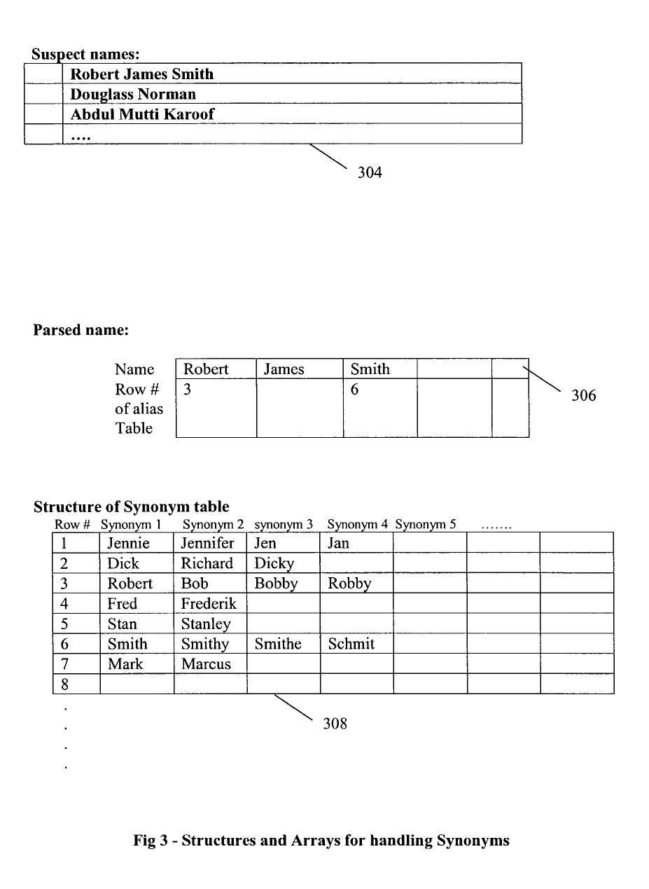

In step 108, the invention checks each component word within the Suspect name and determines whether or not it has any synonyms. If a word has synonyms, the row number in the synonym table 302 (FIG. 3) is associated with it (i.e., the row number is inserted in the same record as the word string). The operation of steps 106 and 108 are depicted in greater detail in FIG. 2 (described below).

Step 110 represents a loop where each Data name is read sequentially from the database files (or flat files) and compared with all the list of Suspect names.

Step 112 represents a loop that selects each Suspect name to be compared with the current Data name.

In step 114, each Data name is cleaned in a similar way to the Suspect names and converted into lower case.

In step 116 (Exact Match), an exact match is attempted between the current Suspect and Data names. The comparison is made using a standard sub-string matching function. If a match is found, there is no need to do any more matching attempts using different methods. The results are output (steps 118 and 134), and the loop is followed to get the next Suspect name.

In step 120 (Any-Order Matching), the invention attempts to match Suspect and Data names by segmenting the Suspect into its component words and determines whether or not all the words exist within the Data name. If any component word is not found, then the any-order test fails. If a match is found, there is no need to do any more matching attempts using different methods. The results are output (steps 122 and 134), and the loop is followed to get the next Suspect name.

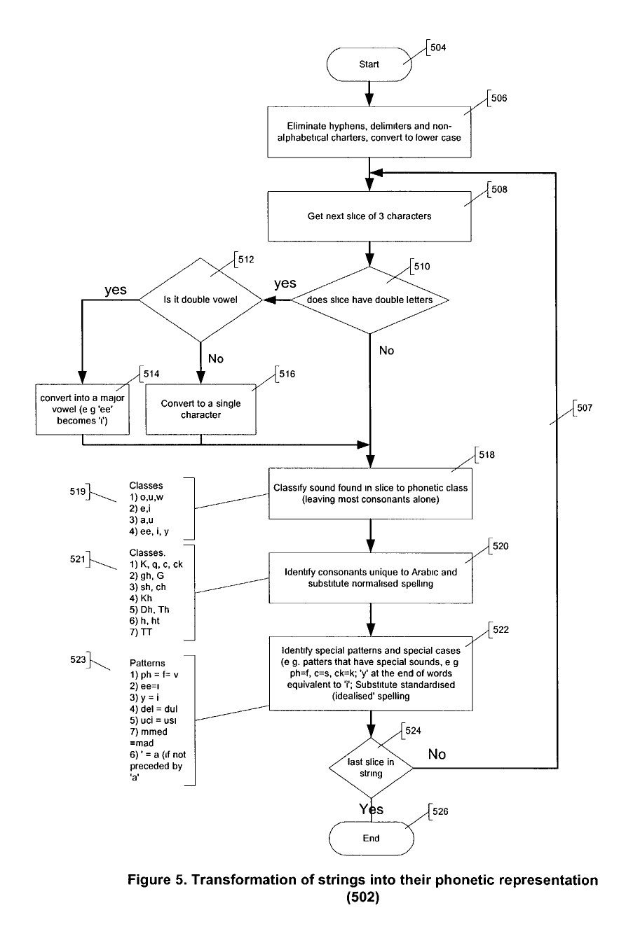

In step 124 (Phonetic Matching), a phonetic version is created for the current Data name (this operation is described fully in FIG. 5). A comparison is made between the phonetic (idealized) versions of the Suspect and Data strings. If a match is found, then the results are output (steps 126 and 134). If not, control is passed to step 128.

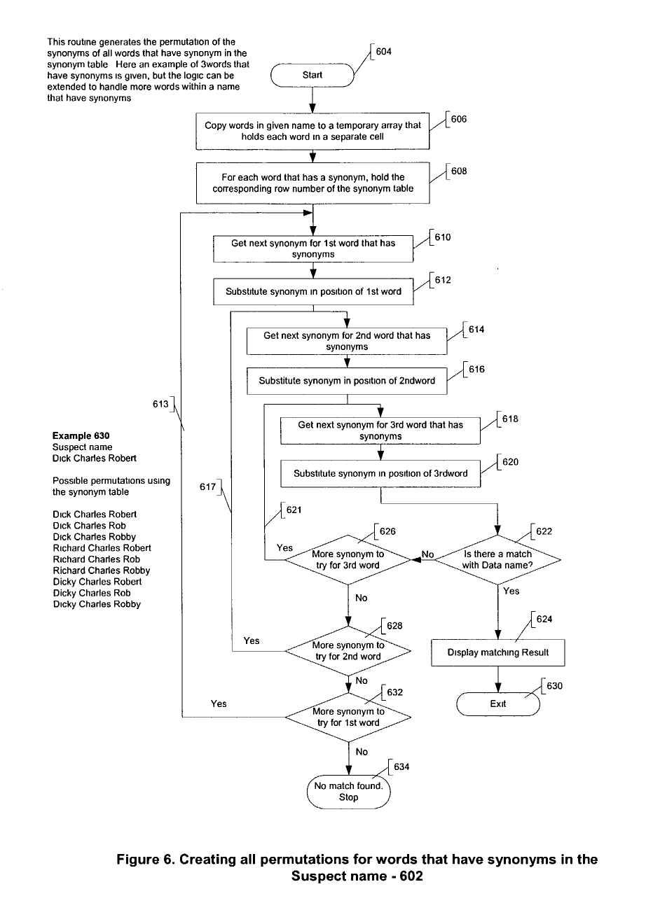

In step 128 (Synonym Substitution), the invention attempts matching by substituting each component word (if it exists in the synonym table) with all its possible synonyms, one at a time, and generating a new version of the Suspect name for each substitution. If the Suspect name has more than one word that can be substituted, the number of permutations for new Suspect names increases dramatically and lengthens the processing time. FIG. 6 describes the details of the synonym substitution process in greater detail. If a match is found, there is no need to do any more matching attempts using different methods. The results are output (steps 130 and 134), and the loop is followed to get the next Suspect name.

In step 132 (Probabilistic Matching), new Suspect strings made by substituting synonyms are matched either in their normal representation or phonetically, in any-order or probabilistically. As each attempt is made, if a successful match is found, subsequent matching attempts are not made. The results are output (step 134), and the loop is followed to get the next Suspect name.

Step 136 represents the end of the loop for retrieving Suspect names.

Step 138 closes the loop for going through all Data names, taking into account all of the database files or flat files selected for searching.

At the end of the search process, all of the successful matches are either displayed on the computer screen or saved to a text file.

Normalizing Search Terms (Steps 106 and 108)

Steps 106 and 108 shall now be described in greater detail with reference to FIG. 2.

In step 206, the Suspect name is cleaned by erasing leading spaces and multiple spaces between words. In embodiments, spaces are replaced by special delimiters. The Suspect name is also converted to a single case, such as lowercase.

In step 208, the Suspect name is further cleaned by erasing non-alphabetic characters, such as dashes, commas and control characters.

In step 210, the Suspect name is divided into its component words. For example, the name “Fred Alan Smith” would be divided into “Fred,” “Alan,” and “Smith.” This is shown in FIG. 3, where records 304, 306, and 308 are used to store “Fred,” “Alan,” and “Smith,” respectively.

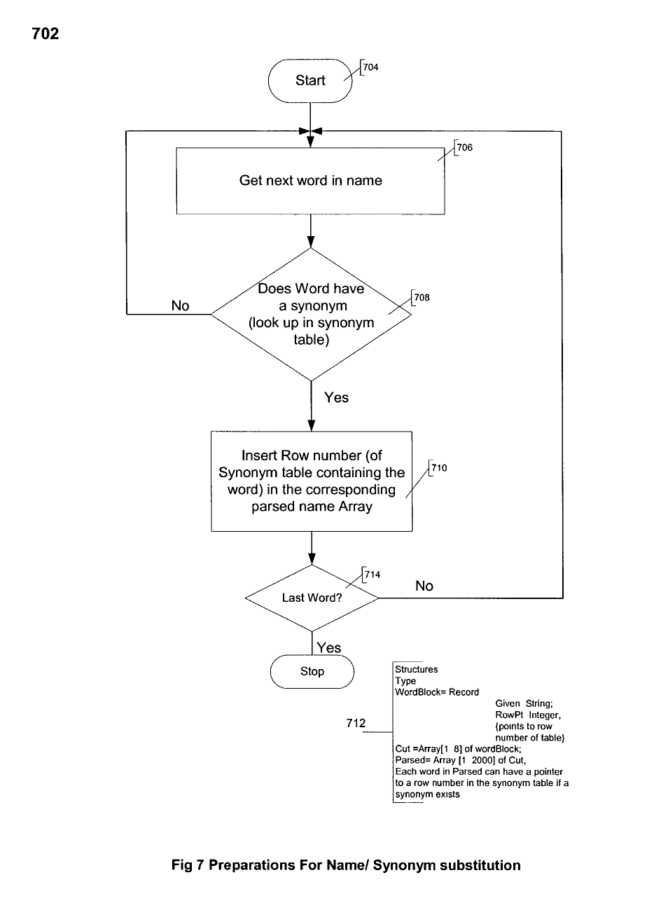

In step 212, each Suspect component word is checked for synonyms by reference to the synonym table 302. For example, the invention would check “Smith” against the entries in the synonym table 302. In this example, a match exists in row 310. The invention updates the record 308 corresponding to this match with a pointer (in this example, 12) of the matching row 310. Such an operation is represented by steps 708 and 710 of FIG. 7. FIG. 7 also illustrates an example form 712 of records 304, 306, and 308.

In step 214, the invention obtains the phonetic representation of each component of the Suspect name. Such an operation is represented by FIG. 5.

In step 216, the next Suspect name is selected, and control passes back to step 206. If there are no more Suspect names to process, then step 220 is performed.

In step 220, the following are stored: the cleaned version of the Suspect name (resulting after step 208); the phonetic representations of the Suspect components (resulting from step 214); and the parsed Suspect components (resulting from step 212).

Any-Order Matching (Step 120)

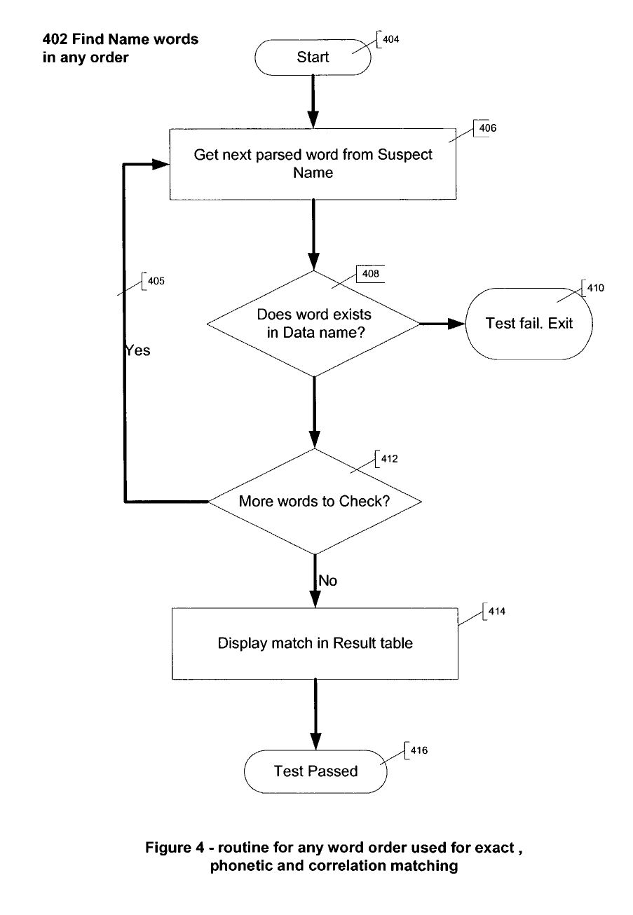

Step 120 shall now be described in greater detail with reference to FIG. 4. Loop 405 iterates through the components of the Suspect name.

In step 406, the next component of the Suspect name is selected (called the selected Suspect component).

In step 408, the selected Suspect component is compared to the selected Data name (previously selected in step 110). If there is not a match, the routine exits in step 410. If there is a match, step 412 is performed.

In step 412, it is determined whether there are additional components of the Suspect name to process. If there are, control returns to step 406. Otherwise, control passes to step 414.

In step 414, matches determined in step 408 are displayed and retained in a table for further processing.

Phonetic Matching (Step 124)

Phonetic Matching (step 124) shall now be described in greater detail with reference to FIG. 5. FIG. 5 represents the operation of the invention when converting Suspect and Data names to their phonetical representation. In an embodiment, the operation of FIG. 5 is performed when the Suspect names are pre-processed (in step 214 of FIG. 2), whereas the operation of FIG. 5 is performed on the Data names “on-the-fly” during the phonetical matching step 124. In alternative embodiments, both Suspect names and Data names are pre-processed, or alternatively both Suspect names and Data names are processed “on-the-fly.”

In step 506, hyphens and delimiters are removed from the name being processed.

Loop 507 iterates through slices of the name being processed. Essentially, this aspect of the invention operates by looking for patterns in a window that move over the name being processed. The slices can be of any length. In an example, the length of the slice is 3 characters.

In step 508, the next slice of the name is selected.

In step 510, the invention determines if the selected slice contains a double letter. Double letters are of importance to embodiments of the invention that are applied to Arabic and similar languages that do not have double letters. Since such languages do not have double letters, the invention operates to normalize the name so they reflect the fact that the native language does not have double letters. If the slice contains a double letter, then step 512 is performed.

In step 512, the invention determines if the slice contains a double vowel. If the slice contains a double vowel then, in step 514, the invention interprets the double vowel to be a major vowel (i.e., a vowel that is both written and pronounced). Accordingly, the invention converts the double vowel into a major vowel. Essentially, the invention has selected various strings to represent major vowels. By performing the conversion described in this step 512, the invention is able to achieve consistency in how major vowels are represented in Suspect and Data names. In other words, the invention is able to normalize Suspect and Data names.

If it is determined in step 512 that the slice does not contain a double vowel, then, in step 516, the double letter is converted to a single letter. Again, since this operation is performed on both Suspect and Data names, such names are normalized, and subsequent comparison operations are much more accurate.

In step 518, the invention classifies the sound represented by the slice to a phonetic class by using the slice as an index into a lookup table 519. Essentially, the invention has defined various phonetic classes, and various string combinations that are associated with such classes. In this step 518, the invention replaces the slice with the defined characters associated with the classes. By doing so, the invention is able to achieve consistency in how phonetic classes are represented in Suspect and Data names. In other words, once again, the invention is able to normalize Suspect and Data names.

In step 520, the invention searches the slice for consonants unique to Arabic (i.e., the native language). In this step 520, the invention replaces such consonants with defined character strings. This is done by using the slice as an index into a lookup table 521. By doing so, the invention is able to achieve consistency in how such unique consonant strings are represented in Suspect and Data names. In other words, once again, the invention is able to normalize Suspect and Data names.

In step 522, the invention searches the slice for special patterns and special cases associated with Arabic (i.e., the native language). In this step 522, the invention replaces such patterns/cases with defined character strings. This is done by using the slice as an index into a lookup table 523. By doing so, the invention is able to achieve consistency in how such patterns/cases are represented in Suspect and Data names. In other words, once again, the invention is able to normalize Suspect and Data names.

The theory behind the processing described above is as follows. Through rules, observation, and/or experience, it has been determined that there are certain patterns that are employed when translating a name from one language (such as Arabic) to another (such as English). There may be multiple patterns that are used for a given case, and such inconsistency of use results in many variations of spelling of a single name. However, by recognizing such patterns, one is able to normalize names to facilitate successful matching.

Step 524 and loop 507 indicate that the processing of FIG. 502 is performed on both the Suspect and Data names.

Synonym Substitution (Step 128)

Synonym Substitution (Step 128) shall now be described in greater detail with reference to FIG. 6. FIG. 6 operates to identify all of the variants of a name given and possible synonyms for components of the name (such as “Jennie,” “Jennifer,” and “Jan”).

In step 606, the name is copied into a temporary array such that each component of the name is stored in an individual cell.

In step 608, the next component of the name that has a synonym (determined by reference to the records 306, 308) is selected. This component is referred to as the “first component.”

In step 610, the next synonym for the selected component (selected in step 608) is selected. For example, for component “Smith” in row 308 of FIG. 3, the synonym “Smithy” is selected.

In step 612, a new name string is generated by inserting the synonym selected in step 610 into the name. Steps 610 and 612 are repeated for each synonym of the first component (this is represented by loop 613).

In step 614, the next component of the name that has a synonym (determined by reference to the records 306, 308) is selected. This component is referred to as the “second component.”

In step 616, the next synonym for the selected component (selected in step 614) is selected. A new name string is generated by inserting the synonym selected in step 616 into the name. Steps 614 and 616 are repeated for each synonym of the name (this is represented by loop 617).

Steps 618 and 620 do a similar function for the third component (if one exists) to select and substitute its synonyms in turn via the loop 621.

After Step 620, a different variant of the name exists. In step 622, this variant name is compared with the selected Data name (previously selected in step 110). If there is a match then, in step 624, the results are retained for further processing (such as display to the user).

Thus, step 613 represents a loop to iterate through the synonyms of the first component, step 617 represent a loop to iterate through the synonyms of the second component (if has synonyms), and step 621 represents a loop to iterate through the synonyms of the third component (if it has synonyms).

Accordingly, FIG. 6 operates by iterating through components of the name that have synonyms. Such iteration is performed by stepping through the corresponding synonyms. The operation of the particular example of FIG. 6 is shown as operating on names that have three components with synonyms. In practice, however, FIG. 6 can operate with names having any number of components with synonyms.

Operation of FIG. 6 is further illustrated by an example 630 shown in FIG. 6.

Correlation/Probabilistic Matching (Step 132)

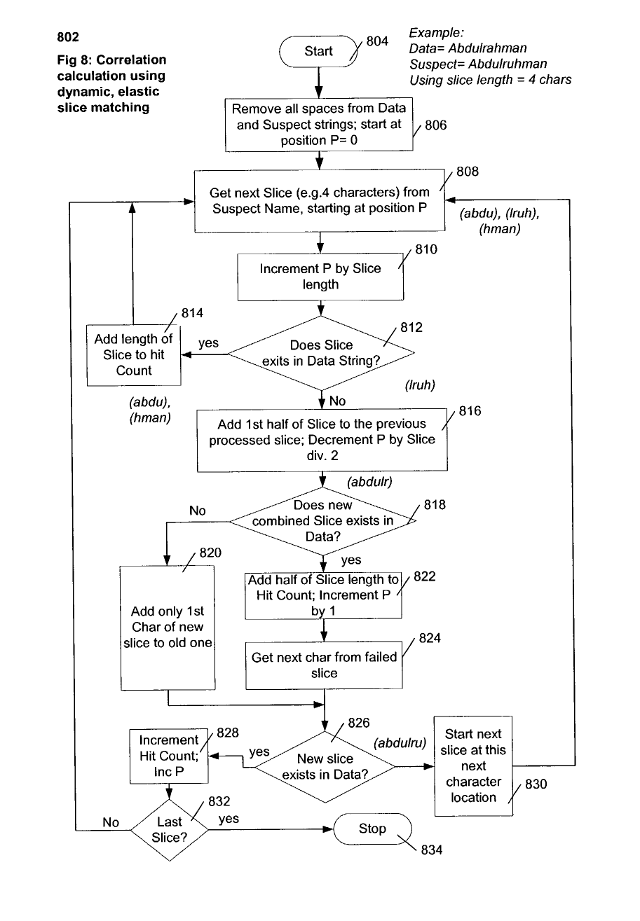

Probabilistic Matching (Step 132) shall now be described in greater detail with reference to FIG. 8. FIG. 8 operates by looking at the Suspect name in slices (in an embodiment, each slice is 4 characters) (step 808). A comparison is made to determine if the Suspect slice exists in the Data name (step 812). If yes, then a Hit Count is incremented by the length of the slice (step 814). If not, then the first half of the slice is concatenated to the previous processed slice (step 816), and that new resulting string is compared to the Data (step 818). If there is a match, then the Hit Count is incremented by the length of half of a slice (822). If not, then the first single character of the slice is concatenated to the previous processed slice (step 820), and that new resulting string is compared to the Data (step 826). If there is a match, then the Hit Count is incremented by one (828).

After the entire Suspect name is processed in this manner, the resulting Hit Count is evaluated. The higher the Hit Count, the greater the probability that there is a match between the Suspect and the Data names. In an embodiment, such evaluation is performed by determining a ratio as follows:

Ratio=100*Hit Count/Length of Suspect name

If the ratio is greater than some specified value, such as 80%, then it is determined that there is a high probability that the Suspect matches the Data.

While various embodiments of the present invention have been described above, it should be understood that they have been presented by way of example only and not limitation. It will be understood by those skilled in the art that various changes in form and details may be made therein without departing from the spirit and scope of the invention as defined in the appended claims.

For example, in the foregoing, the invention was described in terms of processing Suspect names and Data names. More generally, the invention is applicable to any database-searching application that involves Suspect terms (or objects) and Data terms (or objects).

Thus, the breadth and scope of the present invention should not be limited by any of the above-described exemplary embodiments, but should be defined only in accordance with the following claims and their equivalents.

What is claimed is:

1. A method of comparing a first term to a second term, comprising the steps of:
(1) normalizing said first term and said second term; and
(2) comparing said first term with said second term to determine whether they match, comprising one or more of:
(a) comparing said first term with said second term using an exact match algorithm;
(b) comparing said first term with said second term using an any-order matching algorithm;
(c) comparing said first term with said second term using phonetic transformation and matching;
(d) comparing said first term with said second term using synonym substitution; and
(e) comparing said first term with said second term using probabilistic matching using novel string-correlation techniques.
